(19) United States
(12) Patent Application Publication
(10) Pub. No.: US 2026/0125610 A1
(43) Pub. Date: May 7, 2026

(54) THERMOPLASTIC-BASED ENERGETIC MATERIAL PRODUCTION

(71) Applicant: Firehawk Aerospace, Inc., Addison, TX (US)

(72) Inventors: Michael Joseph Baier, Garland, TX (US); Nicholas Shane Podany, Euless, TX (US)

(21) Appl. No.: 18/934,633

(22) Filed: Nov. 1, 2024

(51) Int. Cl. C10L 9/12; B33Y 70/10; C10L 5/14; C10L 5/36

(52) U.S. Cl. CPC C10L 9/12; B33Y 70/10; C10L 5/14; C10L 5/363; C10L 2200/0218

(57) ABSTRACT

An energetic material includes a matrix of a thermoplastic polymer and an oxidizer distributed in the thermoplastic polymer matrix. The energetic material can be produced, for example, by a method that includes adding the oxidizer to the thermoplastic polymer while the thermoplastic polymer is in a softened state to form a mixture, which is then cooled to produce the energetic material.

### TECHNICAL FIELD

This disclosure relates to production of thermoplastic-based energetic material.

### BACKGROUND

There are various types of chemical rocket propulsion systems. Liquid rocket engines use liquid-phase propellants. Solid rocket motors use solid-phase propellants. In some cases, additive manufacturing can be used to deposit propellant material and solidify to form a structure composed of a stacked set of layers for forming a solid propellant material. Additive manufacturing allows for the ability to produce complex shapes or geometries that may otherwise be infeasible to construct by hand, including hollow parts or parts with internal structures.

### SUMMARY

This disclosure describes technologies relating to thermoplastic-based energetic material. The subject matter described in this disclosure can be implemented in particular implementations, so as to realize one or more of the following advantages. The energetic material described is shelf-stable and can be stored for extended periods of time (e.g., for at least six months) after production and before use. The energetic material described includes thermoplastics, which allows the energetic material to be re-processable. The re-processability of the energetic material provides flexibility in that characteristics of the energetic material can be altered, if desired, by re-processing the energetic material (e.g., by melting) and introducing additional components into the formulation and/or diluting components of the formulation. In contrast, other conventional energetic materials including thermoset material(s) cannot be re-processed because once cured, thermosets remain permanently cured. In such conventional energetic materials, if there are any flaws or concerns with certain units produced from a batch of materials, such units cannot be re-processed and would likely need to be disposed. The re-processability of the energetic material provides flexibility in manufacturing as well. For example, the energetic material can be re-processed by an additive manufacturing system for depositing the energetic material onto the surface of another material, such as a solid rocket motor. As another example, the energetic material can be re-processed by an additive manufacturing system for 3D printing the energetic material to form a desired shape of the energetic material. The systems and processes described are flexible in that they can be operated in a batch process or a continuous process. A continuous process can achieve the same production throughputs as an analogous batch process, but at any specific moment in time, less of the active material (e.g., combustion material) is in use in comparison to the analogous batch process, resulting in less waste of base materials and enhanced safety. In some cases, the energetic material includes a solid fuel additive that increases an energy density of the energetic material, which can be particularly useful for solid rocket motors or hybrid rocket engines.

The details of one or more implementations of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1A is a schematic diagram of an example thermoplastic-based energetic material.

FIG. 1B is a schematic diagram of an example feedstock supply kit including the thermoplastic-based energetic material of FIG. 1A.

FIG. 2 is a schematic diagram of an example system for producing a thermoplastic-based energetic material.

FIG. 3 is a flow chart of an example method for producing a thermoplastic-based energetic material.

FIG. 4 is a flow chart of an example method for producing a thermoplastic-based energetic material.

FIG. 5 is a flow chart of an example method for producing and using a thermoplastic-based energetic material.

FIG. 6 is a flow chart of an example method for producing and storing a thermoplastic-based energetic material.

### DETAILED DESCRIPTION

This disclosure describes production of thermoplastic-based energetic material. The thermoplastic-based energetic material can be used, for example, to fabricate solid propellant grains for solid rocket motors or to fabricate hybrid rocket engine fuel grain assemblies including both hybrid fuel grain material and solid propellant.

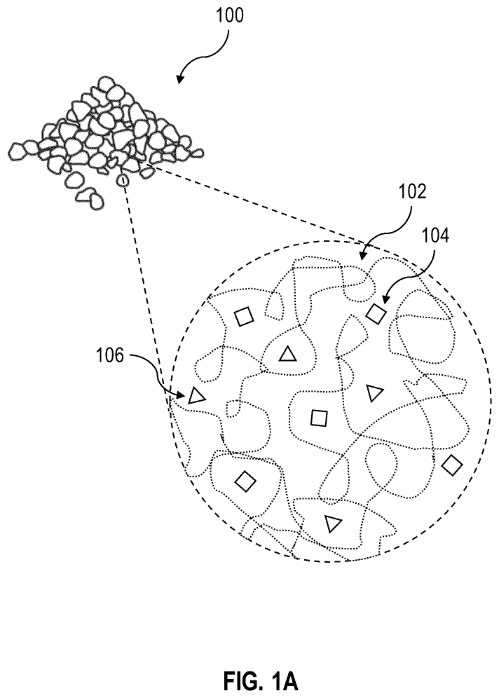

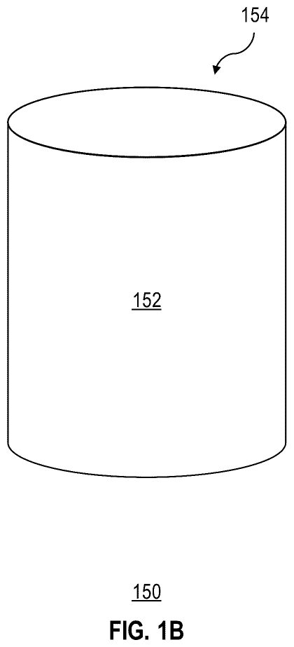

FIG. 1A is a schematic diagram of an example thermoplastic-based energetic material 100. The energetic material 100 includes a thermoplastic polymer matrix 102. The energetic material 100 includes an oxidizer 104 that is distributed in the thermoplastic polymer matrix 102. In some implementations, as shown in FIG. 1A, the energetic material 100 is in the form of pellets. The pellets of the energetic material 100 can be sized, for example, to be used as feedstock for additive manufacturing (e.g., 3D printing). In some implementations, the pellets of the energetic material 100 have at least one dimension (e.g., width, length, height, or diameter) in the range from about 2 millimeters (mm) to about 4 mm. In some implementations, the energetic material 100 is in the form of a powder.

The thermoplastic polymer matrix 102 includes a thermoplastic polymer or a mixture of thermoplastic polymers. In some implementations, the thermoplastic polymer making up the thermoplastic polymer matrix 102 includes thermoplastic polyurethane (TPU), polyurethane (PU), polylactic acid (PLA), acrylonitrile butadiene styrene (ABS), polyvinylidene fluoride (PVDF), polymethyl methacrylate (PMMA), polyethylene (PE), or any combinations of these. In some implementations, the thermoplastic polymer included in the thermoplastic polymer matrix 102 is itself an energetic material. For example, the thermoplastic polymer included in the thermoplastic polymer matrix 102 is a homogeneous solid propellant with a high energy density that can release energy at a rate/timescale at which it is considered an energetic material. In some implementations, the thermoplastic polymer matrix 102 includes the thermoplastic polymer supplemented with an energetic material.

The oxidizer 104 includes oxygen-containing molecules that are available for contributing to combustion of an energetic portion of the energetic material 100. In some implementations, the oxidizer 104 includes potassium nitrate, potassium perchlorate, ammonium nitrate, ammonium perchlorate, sodium perchlorate, or any combinations of these.

In some implementations, as shown in FIG. 1A, the energetic material 100 includes a solid fuel additive 106 that is distributed in the thermoplastic polymer matrix 102. The solid fuel additive 106 can include metal particles. The metal particles of the solid fuel additive 106 can include nanoscale metal particles or microscale metal particles. For example, the solid fuel additive 106 can include nanoscale metal particles having an average dimension (e.g., diameter) of less than about 1 micrometer (μm) or in the range from about 1 nanometer (nm) to about 500 nm, 500 nm or less, or 100 nm or less, e.g., 500 nm, 400 nm, 300 nm, 200 nm, 100 nm, 50 nm, 20 nm, 10 nm, or another diameter that is less than 1 μm. For example, the solid fuel additive 106 can include microscale metal particles having an average dimension (e.g., diameter) in the range from about 1 μm to about 1,000 μm, from about 1 μm to about 500 μm, or from about 1 μm to about 100 μm, e.g., 1 μm, 10 μm, 25 μm, 50 μm, 100 μm, 250 μm, 500 μm, or 1000 μm. The metal particles of the solid fuel additive 106 can include aluminum, magnesium, zirconium, boron, or any combinations of these. For example, the solid fuel additive 106 can include nanoscale or microscale particles of aluminum. The energetic material 100 can optionally include additional additive(s), e.g., burn rate modifiers, processing aids, or other suitable additives. The additives can be materials that have decomposition temperatures above a processing or forming temperature of the energetic material 100, and that, when added, do not result in the propellant ignition temperature falling below the forming temperature of the energetic material 100. For instance, this decomposition temperature criterion for the additive can be relevant when additive manufacturing is used to form the energetic material 100 or form a solid propellant material from the energetic material 100.

In some implementations, the solid fuel additive 106 and the oxidizer 104 are present in the energetic material 100 at a stoichiometric molar ratio for satisfying complete combustion of the solid fuel additive 106. For example, a sufficient amount of the oxidizer 104 is present in the energetic material 100, such that enough oxygen (from the oxidizer 104) is present in the energetic material 100 for complete combustion of the solid fuel additive 106 present in the energetic material 100. In some implementations, the energetic material 100 includes from about 10 weight percent (wt. %) to about 50 wt. %, from about 10 wt. % to about 40 wt. %, from about 10 wt. % to about 30 wt. %, from about 10 wt. % to about 20 wt. %, from about 20 wt. % to about 50 wt. %, from about 20 wt. % to about 40 wt. %, from about 20 wt. % to about 30 wt. %, from about 30 wt. % to about 50 wt. %, from about 30 wt. % to about 40 wt. %, or from about 40 wt. % to about 50 wt. % of the solid fuel additive 106. In some implementations, the energetic material 100 includes from about 50 wt. % to about 75 wt. % of the oxidizer. In some implementations, the energetic material 100 includes from about 10 wt. % to about 25 wt. % of the thermoplastic polymer that forms the thermoplastic polymer matrix 102. In a specific example, the energetic material 100 suitable for deposition by additive manufacturing contains 20 wt. % thermoplastic polyurethane binder (e.g., Pearlstick™ 5703, Lubrizol, Brecksville, OH), 15 wt. % H2 aluminum solid fuel additive having an average particle size of about 3.5 μm, and 65 wt. % potassium perchlorate solid oxidizer.

In some implementations, the thermoplastic polymer of the thermoplastic polymer matrix 102 serves as a fuel material, e.g., in place of or in addition to the solid fuel additive 106. For example, the oxidizer 104 can be distributed in the thermoplastic polymer matrix 102, resulting in a mixture that can sustain combustion independent of addition of the solid fuel additive 106 (in such cases, the solid fuel additive 106 may be omitted).

Additive manufacturing of the energetic material 100 can be performed using shelf-stable solid propellant material formulations. The energetic material 100 can, for example, be shelf-stable at ambient temperature for at least 6 months. This enables solid propellant grains or hybrid fuel grain assemblies to be manufactured on-demand, e.g., on location. Additive manufacturing of solid propellant grains allows for flexibility in the composition of the energetic material 100. For instance, in a solid propellant grain, the formulation of the energetic material 100 can vary radially (e.g., from the innermost layer of concentric beads defining the wall of the combustion port to the outermost layer of concentric beads defining the exterior surface of the solid propellant grain) or axially (e.g., along the length of the solid propellant grain). Alternatively or additionally, local, discontinuous variations in composition can be implemented. For instance, small, discontinuous sections of one solid propellant formulation can be embedded within another formulation that forms the bulk of the solid propellant grain.

Solid propellant grains with internal composition variations can be relevant for providing desired energy (e.g., thrust) profiles. In an example, interior solid propellant material formulations can be incorporated into a solid propellant grain to form a wired endburner structure, in which one formulation of solid propellant material is embedded within a different formulation of solid propellant material to enhance heat transfer into the solid propellant grain by tailoring the thermal transport properties of the various formulations. For instance, the embedded formulation can be a reactive energetic that burns more rapidly than the surrounding formulation and causes ignition of the surrounding material once initiated, thereby allowing new combustion ports to open up within the solid propellant grain. Such approaches can improve the overall propellant load within a given solid rocket motor without sacrificing volume. Other interior configurations of solid propellent material including the energetic material 100 can provide other functional advantages. For instance, in conventional solid rocket motors, a wired endburner uses thermally conductive materials, such as metal wires (e.g., copper) and/or reactive materials (e.g., an aluminum core with an outer shell made of palladium and ruthenium) that can react rapidly and ignite the material around the reactive materials to propagate heat into the propellant volume to improve burning rates. Interior the energetic material 100 having higher thermal conductivity than the surrounding material can be configured to have similar functionality, while advantageously providing consumable material rather than wires occupying the endburner space.

The process parameters of the additive manufacturing system are set such that the energetic material 100 is flowable but does not ignite. For instance, the processing temperature at which the energetic material 100 is printed, extruded, or otherwise deposited is set to provide a safe margin between the processing temperature and the ignition temperature of the components of the energetic material 100, and also to provide a safe margin between the processing temperature and the decomposition temperature of the components of the energetic material 100. For example, the decomposition temperatures of the components of the energetic material 100 can be determined by a thermogravimetric analysis (TGA) in which a mass of a sample of the energetic material 100 is measured over time as temperature changes (e.g., increases). The mass measurement of the sample of the energetic material 100 as temperature changes can provide information about the energetic material 100, such as phase transitions, absorption, adsorption, desorption, chemisorptions, thermal decomposition (e.g., constituent degradation temperatures), melt temperature, ignition temperature, and composition. In some implementations, the energetic material 100 can be analyzed by a differential scanning calorimetry with thermogravimetric analysis (DSC-TGA). Additionally, when the energetic material 100 is deposited in conjunction with hybrid fuel grain material to form hybrid rocket engine fuel grain assemblies, the processing temperature for the deposition of the fuel grain material is also set to provide a sufficient margin of safety. In some examples, the composition of the thermoplastic polymer 102, oxidizer 106, and any additives (such as the solid fuel additive 106) is selected to enable this temperature differential to be achieved. In some implementations, the processing temperature is greater than a required qualification temperature for a given munition, motor, or rocket in which the energetic material 100 is to be used. For example, the processing temperature at which the energetic material 100 melts and becomes processable is greater than the required hot qualification temperature, such that the energetic material 100 can be expected to pass hot qualification tests without becoming malleable. In some implementations, a glass transition temperature of the energetic material 100 is less than the required qualification temperature for a given munition, motor, or rocket in which the energetic material 100 is to be used. If the energetic material 100 transitions to glass-like behavior above the cold qualification temperature (i.e., the glass transition temperature is greater than the required cold qualification temperature), the energetic material 100 may disadvantageously be subject to becoming overly brittle and more likely to deform (e.g., break or crack) under typical loading conditions and would be at increased risk of failing the cold qualification test. The processing temperature can be adjusted based on the desired end use for the energetic material 100. For example, the processing temperature may be adjusted to meet the typically stringent requirements for use of the energetic material 100 in air-to-air munitions. In some implementations, the processing temperature is in a range of from about 120 degrees Celsius (° C.) to about 190° C. For example, the processing temperature can be in a range of from about 120° C. to about 140° C., from about 140° C. to about 170° C., or from about 170° C. to about 190 Process parameters for additive manufacturing of the energetic material 100 can be tuned to control behavior of the energetic material 100 during and/or after printing. For instance, processing aids such as additives can be introduced into the energetic material 100 to tune the melt viscosity, solidification time, or other characteristics of the energetic material 100. As an example, a base thermoplastic material (e.g., a thermoplastic polymer or mixture of thermoplastic polymers) with a given melting point can be blended with another melt-processable material such as a different thermoplastic material with a lower melting point. This mixture will have a lower viscosity at lower temperature than the base thermoplastic material alone, which can enable the processing temperature to be reduced. For instance, ethylene-vinyl acetate (EVA), which is a copolymer of ethylene and vinyl acetate, can be added to a base thermoplastic material, and the melting temperature of the mixture can be tuned based on the relative quantities of the ethylene and the vinyl acetate in the copolymer. Other examples of processing aids can include processing aids used with conventional solid propellant formulations, e.g., plasticizers, provided the processing aid is compatible with the conditions of additive manufacturing.

In some examples, additive manufacturing of the energetic material 100 is achieved using a twin-screw extruder system with multiple feeders. The components of the energetic material 100 (e.g., oxidizer 104, thermoplastic polymer matrix 102, and any additives, such as the solid fuel additive 106) are fed into the extruder system in metered quantities and in specified order, and the shearing action of the internal screw elements mixes the components. In some implementations, this approach can avoid heating or melting of the thermoplastic material, thus mitigating ignition hazards. For instance, when the thermoplastic material of the energetic material 100 is premixed, softened, or dissolved in a suitable solvent, the extruder system can be operated at relatively low temperatures, e.g., at ambient temperature, reducing risk of accidental ignition. Solvent can subsequently be removed via vacuum sections and recovered and/or recycled, reducing waste generation. In some examples, with suitable extruder design (e.g., a twin-screw extruder system under suitable processing conditions), heat and/or shear from the extruder can melt the polymer and mix the constituents, thereby avoiding the use of solvents.

Twin-screw extruder systems can be used for fabrication of additive manufacturing feedstock which is then deposited in a separate additive manufacturing system. In some examples, twin-screw extruder systems can be used for additive manufacturing itself. For instance, a single extruder system can be configured to mix the raw constituents into a homogeneous mixture and to print that mixture.

In some examples, additive manufacturing of both solid propellant material and hybrid fuel grain material is used to fabricate a hybrid fuel grain assembly for a hybrid rocket engine. A hybrid fuel grain assembly is a hybrid fuel grain formed of fuel grain material, and further including a small amount of the energetic material 100, e.g., disposed on an inner surface of the hybrid fuel grain.

A fuel grain material generally refers to a solid, combustible fuel material for use in a hybrid rocket engine. Generally, a fuel grain material is a material that does not sustain combustion on its own, but is combustible in the presence of a separate oxidizer to thereby allow the fuel grain material and oxidizer to serve as a propellant. Example fuel grain materials include a polymer-based rocket fuel material, e.g., such as acrylonitrile butadiene styrene (ABS) thermoplastic or another polymer based rocket fuel material having desired combustion properties. Example fuel grain materials can also include micron-scale or nanoscale additives, such as micron-scale or nanoscale metal particles (e.g., aluminum or magnesium particles), microscale or nanoscale metal hydride particles, microscale or nanoscale polymer particles, or other suitable additives. In some examples, the microscale or nanoscale metallic particles are passivated with a polymer coating. In some examples, the microscale or nanoscale metallic particles have an oxide shell (e.g., aluminum particles can have an aluminum oxide shell). The additive particles can be of any suitable geometry, e.g., spheres, flakes, ellipses, or other geometries. In some examples, fuel grain materials do not contain an oxidizer. In some examples, the fuel grain material contains an additive that is an oxidizer, e.g., in small enough quantities that the oxidizer content in the fuel grain material is insufficient to sustain combustion. In some implementations, the fuel grain material is composed of from about 75 wt. % to about 95 wt. % of the hybrid rocket fuel material and from about 5 wt. % to about 25 wt. % of the microscale or nanoscale additive. In some implementations, the fuel grain material includes from about 5 wt. % to about 90 wt. %, from about 5 wt. % to about 80 wt. %, or from about 5 wt. % to about 70 wt. % of the microscale or nanoscale additive. In some examples, larger concentrations of additives can be present in the fuel grain material.

The small amount of solid propellant material in a hybrid fuel grain assembly aids with ignition of the fuel grain material, which advantageously enables hybrid rocket engines to perform comparably to solid rocket motors during initial startup transients. For instance, the fast action of the solid propellant material rapidly provides heat to the hybrid fuel grain material and enables a rapid increase in engine pressure, which shortens the transient startup period of the hybrid rocket engine. In some examples, the solid propellant material in an otherwise hybrid rocket engine can produce sufficient thrust to initially accelerate a vehicle or other movable device while the system transitions into hybrid operation.

Additive manufacturing of hybrid fuel grain assemblies including both hybrid fuel grain material and the energetic material 100 allows for flexibility in terms of the compositional profile of the fuel grain assemblies. For instance, manufacturing hybrid fuel grain assemblies using additive manufacturing can enable fabrication of customized arrangements of materials, e.g., fabrication of hybrid fuel grain assemblies having the energetic material 100 interspersed with hybrid fuel grain material, hybrid fuel grain assemblies having different solid propellant material formulations in different locations, or hybrid fuel grain assemblies having controllable surface morphologies. These customized materials arrangements in turn enable target energy (e.g., thrust) profiles to be achieved.

FIG. 1B is a schematic diagram of an example feedstock supply kit 150. The supply kit 150 includes a container 152. The supply kit 150 includes pellets 154. The pellets 154 can be composed of, for example, the energetic material 100. The pellets 154 can be stored in the container 152. The supply kit 150 can be stored for an extended period of time, as the pellets 154 are shelf-stable. For example, the supply kit 150 can be stored until a user is ready to use the pellets 154. In cases in which the pellets 154 are composed of the energetic material 100, the pellets 154 can optionally be re-processed prior to use due to the re-processibility of the thermoplastic making up the thermoplastic polymer matrix 102 of the energetic material 100. For example, in cases where a user may want different characteristics from the pellets 154 that were originally ordered/provided, the user may re-process the pellets 154 to add or dilute constituents. In such cases, the user may re-melt the pellets 154 and add or dilute constituents of the energetic material 100 to produce pellets having different characteristics.

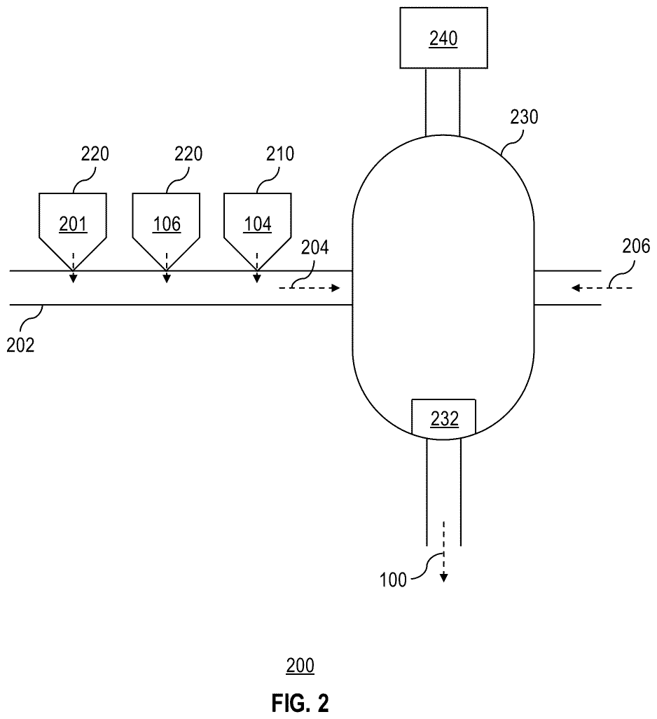

FIG. 2 is a schematic diagram of an example system 200 for producing thermoplastic-based energetic material, such as the energetic material 100. The system 200 includes a flow channel 202 configured to flow a softened thermoplastic polymer material 201. The softened thermoplastic polymer material 201 is flowable and can flow through the flow channel 202. In some implementations, as shown in FIG. 2, the system 200 includes a thermoplastic hopper 205 containing the thermoplastic polymer material 201. The thermoplastic hopper 205 is connected to the flow channel 202 for introducing the thermoplastic polymer material 201 to the flow channel 202. In some implementations, the thermoplastic hopper 205 is equipped with an extruder (e.g., a twin screw extruder) for softening the thermoplastic polymer material 201 and expelling the softened thermoplastic polymer material 201 into the flow channel 202. In some implementations, the thermoplastic polymer material 201 is already in a softened state within the thermoplastic hopper 205 and flows into the flow channel 202.

The softened thermoplastic polymer material 201 can include, for example, a thermoplastic polymer or a mixture of thermoplastic polymers. The softened thermoplastic polymer material 201 can be a thermoplastic polymer or a mixture of thermoplastic polymers that has been heated to a temperature that is equal to or greater than a melt temperature or glass transition temperature of the thermoplastic polymer material 201 such that the softened thermoplastic polymer material 201 is flowable. In some implementations, the melt temperature is in a range from about 100 degrees Celsius (° C.) to about 190° C. The melt temperature can be, for example, less than or equal to the processing temperature. In some implementations, the glass transition temperature is less than 0° C., for example, in a range from about −65° C. to about −40° C. In some implementations, the softened thermoplastic polymer material 201 includes material that is not a thermoplastic polymer, such as a solvent configured to dissolve a thermoplastic polymer or mixture of thermoplastic polymers. In cases where the softened thermoplastic polymer material 201 includes the solvent, the softened thermoplastic polymer material 201 may be in the form of a slurry. In some implementations, the solvent includes acetone, ethyl acetate, methyl ethyl ketone, xylene, or any combinations of these. In cases where the softened thermoplastic polymer material 201 includes the solvent, the solvent is carefully selected to ensure that any solid additives of interest are insoluble in the solvent, do not react with the solvent, and do not degrade in response to exposure to the solvent.

The system 200 includes an oxidizer hopper 210 containing the oxidizer 104. The oxidizer hopper 210 is connected to the flow channel 202 for introducing the oxidizer 104 to the softened thermoplastic polymer material 201 flowing through the flow channel 202. The oxidizer 104 and the softened thermoplastic polymer material 201 can mix within the flow channel 202. In some implementations, the system 200 includes an inline mixer installed within the flow channel 202 to facilitate mixing of the oxidizer 104 and the softened thermoplastic polymer material 201.

In some implementations, as shown in FIG. 2, the system 200 includes a solid fuel additive hopper 220 containing the solid fuel additive 106. In cases where the solid fuel additive 106 is not to be added to the formulation for forming the energetic material 100, the solid fuel additive hopper 220 may be omitted. The solid fuel additive hopper 220 can be connected to the flow channel 202 for introducing the solid fuel additive 106 to the softened thermoplastic polymer material 201 flowing through the flow channel 202. The solid fuel additive 106 and the softened thermoplastic polymer material 201 can mix within the flow channel 202. In some implementations, the system 200 includes an inline mixer installed within the flow channel 202 to facilitate mixing of the solid fuel additive 106 and the softened thermoplastic polymer material 201. As shown in FIG. 2, in cases where the system 200 includes the solid fuel additive hopper 220, the solid fuel additive hopper 220 is connected to the flow channel 202 upstream of the connection between the flow channel 202 and the oxidizer hopper 210. In some implementations, the connection between the flow channel 202 and the oxidizer hopper 210 is located along the flow channel 202 such that introduction of the oxidizer 104 to the softened thermoplastic polymer material 201 (and in some cases, the solid fuel additive 106) is delayed as much as possible for minimizing the potential for unplanned ignition of the energetic material 100.

The system 200 includes a vessel 230 connected to the flow channel 202 downstream of the oxidizer hopper 210. The mixture 204 including the oxidizer 104 and the softened thermoplastic polymer material 201 (and in some cases, the solid fuel additive 106) flows from the flow channel 202 into the vessel 230. The mixture 204 can, for example, be in the form of a slurry. In cases where solvent has been included to dissolve the thermoplastic polymer material 201, an antisolvent 206 may be added to the mixture 204 within the vessel 230 to separate the solvent from the mixture 204. The antisolvent 206 is configured to crystallize or precipitate the solvent for separating the solvent from the mixture 204. The antisolvent 206 and the solvent are miscible, such that the two mix readily and do not separate over time if left alone. In cases where the antisolvent 206 is added to the mixture 204 to separate the solvent from the mixture 204, the antisolvent 206 is carefully selected to ensure that any solid additives of interest are insoluble in the antisolvent 206, do not react with the antisolvent 206, and do not degrade in response to exposure to the antisolvent 206. Further, the antisolvent 206 is carefully selected to ensure that the thermoplastic polymer material 201 is insoluble in the antisolvent 206. In some implementations, the antisolvent 206 includes isopropyl alcohol, hexane, water, or any combinations of these. In some cases, the antisolvent 206 may not be necessary, and the mixture 204 can simply be heated to evaporate the solvent from the mixture 204. In some implementations, the antisolvent 206 is added to the mixture 204 within the vessel 230 and heated within the vessel 230 to separate and evaporate the solvent from the mixture 204. In cases where the antisolvent 206 is added to the mixture 204 within the vessel 230, the thermoplastic polymer (or mixture of thermoplastic polymers) and the oxidizer 104 (and, in cases where the mixture 204 includes the solid fuel additive 106, the solid fuel additive 106) are insoluble in the antisolvent 206. In some implementations, as shown in FIG. 2, the system 200 includes a vacuum pump 240 that generates a vacuum within the vessel 230 for facilitating evaporation of the solvent out of the mixture 204. In some cases, the vacuum pump 240 may not be necessary and can be omitted. Removing the solvent from the mixture 204 forms the energetic material 100.

In some implementations, the vessel 230 includes an extruder 232. The extruder 232 can include, for example, a piston extruder (also referred to as a ram extruder) or a screw extruder. The screw extruder can be, for example, a single screw extruder or a multiple screw extruder (such as a twin-screw extruder, a split twin-screw extruder, or a three-screw extruder). In some implementations, the screw extruder is a vented extruder. In cases where the vessel 230 includes the extruder 232, the energetic material 100 can be extruded to produce an extrudate, and the extrudate can be cut into pellets (such as the pellets 154). In some implementations, extruding the energetic material 100 includes generating a melt mix slurry of the energetic material 100 and extruding the melt mix slurry through the extruder 232. In cases where it is desirable for the energetic material 100 to be in powder form, the pellets 154 can be pulverized, for example, in a rotary drum mill to reduce the pellets 154 into a powder.

The system 200 can be operated as a continuous process (for example, at steady state) in which the energetic material 100 is continuously produced, as opposed to a batch process in which set volumes of the energetic material 100 are produced one at a time. In some cases, the system 200 can be operated as a batch process. For example, the system 200 can be operated as a batch process for testing a different formulation of the energetic material 100 for finalizing process parameters before switching to a continuous process.

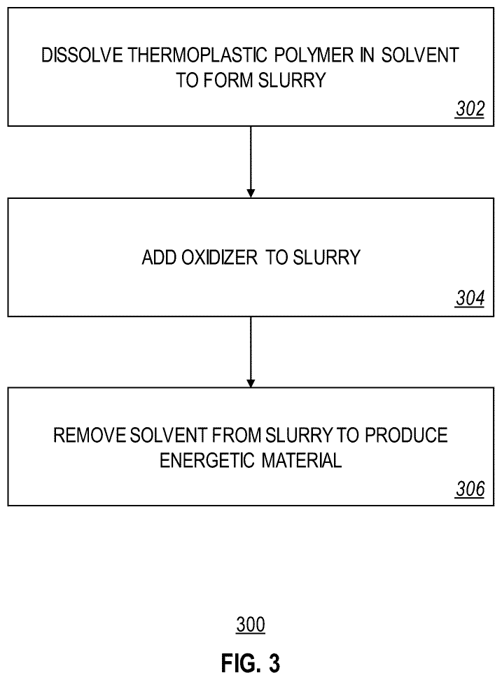

FIG. 3 is a flow chart of an example method 300 for producing a thermoplastic-based energetic material, such as the energetic material 100. At block 302, a thermoplastic polymer is dissolved in a solvent to form a slurry. At block 304, an oxidizer (such as the oxidizer 104) is added to the slurry. After adding the oxidizer 104 to the slurry at block 304, the solvent is removed from the slurry at block 306 to produce an energetic material (such as the energetic material 100) that includes the oxidizer 104 distributed in a matrix of the thermoplastic polymer (such as the thermoplastic polymer matrix 102). In some implementations, removing the solvent from the slurry at block 306 includes washing the slurry with an antisolvent in which the thermoplastic polymer and the oxidizer 104 are insoluble. In some implementations, removing the solvent from the slurry at block 306 includes evaporating the solvent from the slurry by applying heat to the slurry, exposing the slurry to a vacuum, or both. In some implementations, the method 300 is performed as a batch process. In some implementations, the method 300 is performed as a continuous process.

In some implementations, the energetic material 100 produced at block 306 includes a solid fuel additive (such as the solid fuel additive 106) for a solid rocket engine. In some implementations, the method 300 includes dispersing the solid fuel additive 106 in the slurry of the thermoplastic polymer and the solvent. For example, the solid fuel additive 106 can be dispersed in the slurry by adding the solid fuel additive 106 from a first hopper (such as the solid fuel additive hopper 220) that is connected to a flow channel (such as the flow channel 202) containing the slurry. In such implementations, the oxidizer 104 can be added to the slurry at block 304 after dispersing the solid fuel additive 106 in the slurry. For example, the oxidizer 104 can be added to the slurry at block 304 from a second hopper (such as the oxidizer hopper 210) connected to the flow channel 202 downstream from the first hopper (e.g., the solid fuel additive hopper 220) from which the solid fuel additive 106 is added. In some implementations, the method 300 includes forming the energetic material 100 into pellets (such as the pellets 154). In some implementations, the pellets 154 formed are sized to be used as feedstock for additive manufacturing. In some implementations, the pellets 154 formed have at least one dimension (or an average dimension, such as diameter) in the range from about 2 mm to about 4 mm. In some implementations, forming the energetic material 100 into pellets 154 includes extruding the energetic material 100 (for example, using the extruder 232) to produce an extrudate and cutting the extrudate into pellets 154. In some implementations, extruding the energetic material 100 includes generating a melt mix slurry of the energetic material 100 and extruding the melt mix slurry through a screw extruder. In some implementations, the energetic material 100 produced at block 306 is extruded using a piston or screw extruder. In some implementations, the energetic material 100 produced at block 306 is pulverized to form a powder of the energetic material 100.

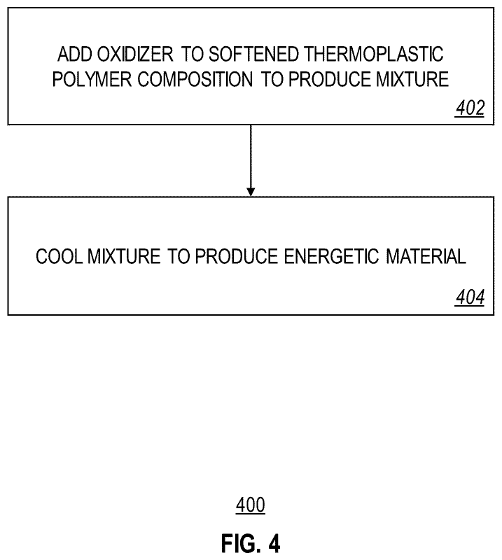

FIG. 4 is a flow chart of an example method 400 for producing a thermoplastic-based energetic material, such as the energetic material 100. At block 402, an oxidizer (such as the oxidizer 104) is added to a softened thermoplastic polymer composition to produce a mixture. In some implementations, the method 400 includes softening a thermoplastic polymer to produce the softened thermoplastic composition prior to adding the oxidizer 104 at block 402. For example, the thermoplastic polymer can be softened by heating the thermoplastic polymer to a temperature that is equal to or greater than a melt temperature of the thermoplastic polymer composition (e.g., a temperature at which the thermoplastic polymer composition melts), adding a solvent to the thermoplastic polymer, or both. In some implementations, the thermoplastic polymer is softened by heating, independent of introduction of a solvent. In some implementations, the method 400 includes dispersing a solid fuel additive (such as the solid fuel additive 106) in a softened thermoplastic polymer to produce the thermoplastic polymer composition prior to adding the oxidizer 104 at block 402. In such implementations, the thermoplastic polymer composition includes a mixture of the softened thermoplastic polymer and the solid fuel additive 106. At block 404, the mixture of oxidizer 104 and softened thermoplastic polymer composition (produced at block 402, and in some implementations, including the solid fuel additive 106) is cooled to produce an energetic material (such as the energetic material 100) that includes the oxidizer 104 in a matrix of the thermoplastic polymer (such as the thermoplastic polymer matrix 102). In some implementations, the method 400 is performed as a batch process. In some implementations, the method 400 is performed as a continuous process.

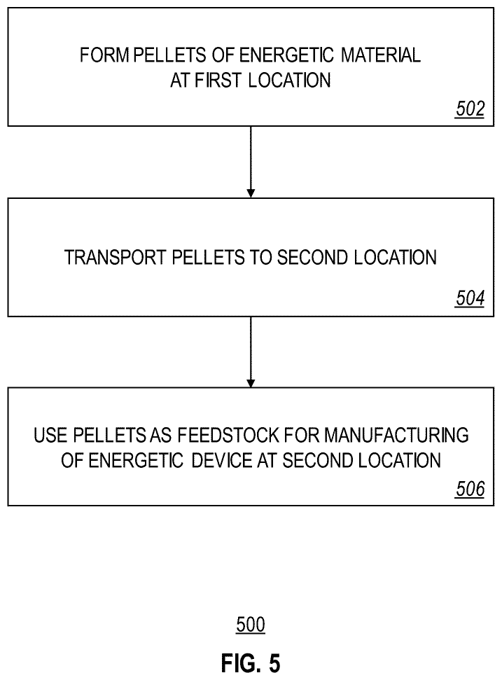

FIG. 5 is a flow chart of an example method 500 for producing and using a thermoplastic-based energetic material, such as the energetic material 100. At block 502, pellets (such as the pellets 154) of an energetic material (such as the energetic material 100) are formed at a first location. Forming the pellets 154 of the energetic material 100 at block 502 can include, for example, any of the methods 300 or 400. At block 504, the pellets 154 (formed at block 502) are transported to a second location. The second location at block 504 is distinct from and located away from the first location at block 502. For example, the second location is located miles away from the first location. In some implementations, the pellets 154 are stored in containers that are shipped at block 504 from the first location to the second location, for example, by a truck. At block 506, the pellets 154 are used as feedstock for manufacturing of an energetic device at the second location. For example, the pellets 154 are used as feedstock at block 506 for an additive manufacturing process to produce solid propellant grains for solid rocket motors, hybrid rocket engine fuel grain assemblies that include both hybrid fuel grain material and solid propellant, or an explosive device. The additive manufacturing process can include extruding the pellets 154 of the energetic material 100 through a nozzle of an additive manufacturing system.

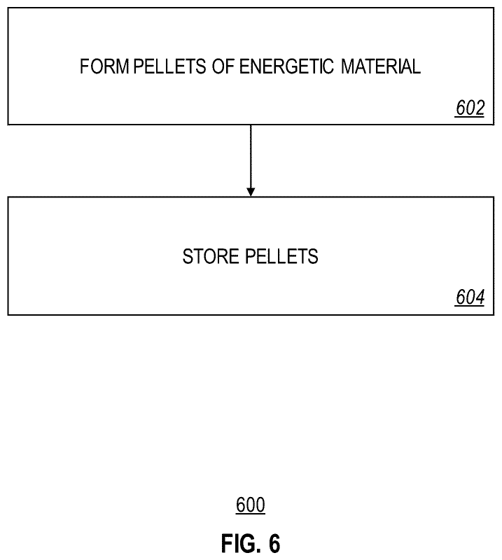

FIG. 6 is a flow chart of an example method 600 for producing and storing a thermoplastic-based energetic material, such as the energetic material 100. At block 602, pellets of a pre-mix energetic material or of an energetic material (such as the energetic material 100) including an oxidizer (such as the oxidizer 104) in a matrix of a thermoplastic polymer (such as the thermoplastic polymer matrix 102) are formed. Forming the pellets of the energetic material 100 at block 602 can include, for example, any of the methods 300 or 400. At block 604, the pellets are stored. Because the pellets of the energetic material 100 are shelf-stable, the pellets can be stored at block 604 for an extended period of time, for example, for at least six months. In some implementations, the pellets of the energetic material 100 are formed at a first location at block 602, and the pellets of the energetic material 100 are stored at a second location at block 604. For example, the first location at which the pellets of the energetic material 100 are formed (block 602) is miles away from the second location at which the pellets of the energetic material 100 are stored (block 604). In some implementations, the pellets of the energetic material 100 are formed at block 602 and stored at block 604 at the same location, or locations that are within a mile of each other.

In some implementations, pellets of a pre-mix material excluding an oxidizer (such as the oxidizer 104) are formed as a pre-mix energetic material at block 602. The pellets of the pre-mix energetic material can be stored at block 604. Because the pellets of the pre-mix energetic material formed at block 602 are shelf-stable, the pellets can be stored at block 604 for an extended period of time, for example, for at least six months. In some implementations, the pellets of the pre-mix energetic material are formed at a first location at block 602, and the pellets of the pre-mix energetic material are stored at a second location at block 604. For example, the first location at which the pellets of the pre-mix energetic material are formed (block 602) is miles away from the second location at which the pellets of the pre-mix energetical material are stored (block 604). In some implementations, the pellets of the pre-mix energetic material are formed at block 602 and stored at block 604 at the same location, or locations that are within a mile of each other. In some implementations, the oxidizer 104 is later added to the pre-mix energetic material to form the energetic material 100. For example, the oxidizer 104 can be added to the pre-mix energetic material to form the energetic material 100 after storing for an extended period of time at block 604. As another example, the oxidizer 104 can be added to the pre-mix energetic material to form the energetic material 100 at a second location, miles away from a first location at which the pre-mix energetic material is formed (block 602).

In some implementations, chemical precursor materials can be used, which once reacted, yield a thermoplastic material of interest to form the thermoplastic polymer matrix 102. The chemical precursor materials can be, for example, in liquid form, which would eliminate the need for a solvent or application of heat to be processable. The chemical precursor materials can be used in a batch process or a continuous process. In place of polymer pellets or slurries, the precursor materials can be mixed homogeneously together along with any additives, such as the solid fuel additive 106. After mixing, the precursor materials can be allowed to react to form the thermoplastic polymer matrix 102. In some implementations, the precursor materials react at room temperature upon exposure to one another via mixing to form the thermoplastic polymer matrix 102. In some implementations, the mixture of precursor materials is heated to facilitate reaction of the precursor materials to form the thermoplastic polymer matrix 102.

### EMBODIMENTS

In an example implementation (or aspect), a method comprises: dissolving a thermoplastic polymer in a solvent to form a slurry; adding an oxidizer to the slurry; and after adding the oxidizer to the slurry, removing the solvent from the slurry to produce an energetic material comprising the oxidizer distributed in a matrix of the thermoplastic polymer.

In an example implementation (or aspect) combinable with any other example implementation (or aspect), the energetic material comprises a solid propellant material for a solid rocket engine.

In an example implementation (or aspect) combinable with any other example implementation (or aspect), the method comprises forming the energetic material into filaments.

In an example implementation (or aspect) combinable with any other example implementation (or aspect), the method comprises forming the energetic material into pellets.

In an example implementation (or aspect) combinable with any other example implementation (or aspect), the method comprises forming the energetic material into pellets sized to be used as feedstock for additive manufacturing.

In an example implementation (or aspect) combinable with any other example implementation (or aspect), the method comprises forming the energetic material into pellets having at least one dimension in the range of 2-4 mm.

In an example implementation (or aspect) combinable with any other example implementation (or aspect), forming the energetic material into pellets comprises: extruding the energetic material to produce an extrudate; and cutting the extrudate into pellets.

In an example implementation (or aspect) combinable with any other example implementation (or aspect), extruding the energetic material comprises generating a melt mix slurry of the energetic material and extruding the melt mix slurry through a screw extruder.

In an example implementation (or aspect) combinable with any other example implementation (or aspect), the method comprises extruding the energetic material using a piston or screw extruder.

In an example implementation (or aspect) combinable with any other example implementation (or aspect), the method comprises storing the pellets.

In an example implementation (or aspect) combinable with any other example implementation (or aspect), the method comprises storing the pellets for at least 6 months.

In an example implementation (or aspect) combinable with any other example implementation (or aspect), the method comprises using the pellets as feedstock in an additive manufacturing process.

In an example implementation (or aspect) combinable with any other example implementation (or aspect), the additive manufacturing process comprises extruding the pellets of the energetic material through a nozzle of an additive manufacturing system.

In an example implementation (or aspect) combinable with any other example implementation (or aspect), the method comprises using the pellets as feedstock for additive manufacturing of a solid propellant grain for a solid rocket motor.

In an example implementation (or aspect) combinable with any other example implementation (or aspect), the method comprises using the pellets as feedstock for additive manufacturing of an explosive device.

In an example implementation (or aspect) combinable with any other example implementation (or aspect), the method comprises pulverizing the energetic material to form a powder of the energetic material.

In an example implementation (or aspect) combinable with any other example implementation (or aspect), removing the solvent from the slurry comprises washing the slurry with an antisolvent, wherein the thermoplastic polymer and the oxidizer are insoluble in the antisolvent.

In an example implementation (or aspect) combinable with any other example implementation (or aspect), removing the solvent from the slurry comprises evaporating the solvent from the slurry by applying heat to the slurry.

In an example implementation (or aspect) combinable with any other example implementation (or aspect), removing the solvent from the slurry comprises evaporating the solvent from the slurry by exposing the slurry to a vacuum.

In an example implementation (or aspect) combinable with any other example implementation (or aspect), the method is performed as a continuous process.

In an example implementation (or aspect) combinable with any other example implementation (or aspect), the method comprises dispersing an energetic additive in the slurry of the thermoplastic polymer and the solvent, wherein the oxidizer is added to the slurry after dispersing the energetic additive in the slurry.

In an example implementation (or aspect) combinable with any other example implementation (or aspect), the energetic additive comprises a solid fuel additive.

In an example implementation (or aspect) combinable with any other example implementation (or aspect), the solid fuel additive comprises metal particles.

In an example implementation (or aspect) combinable with any other example implementation (or aspect), the metal particles comprise nanoscale or microscale metal particles.

In an example implementation (or aspect) combinable with any other example implementation (or aspect), the metal particles comprise nanoscale or microscale particles of aluminum.

In an example implementation (or aspect) combinable with any other example implementation (or aspect), the method comprises adding the energetic additive and the oxidizer at a stoichiometric ratio with respect to combustion of the energetic additive.

In an example implementation (or aspect) combinable with any other example implementation (or aspect), the method comprises adding the energetic additive to the slurry such that the energetic material comprises from about 10 wt. % to about 20 wt. % of the energetic additive.

In an example implementation (or aspect) combinable with any other example implementation (or aspect), the method comprises adding the oxidizer to the slurry such that the energetic material comprises from about 50 wt. % to about 75 wt. % of the oxidizer.

In an example implementation (or aspect) combinable with any other example implementation (or aspect), the method comprises adding the energetic additive to the slurry from a first hopper connected to a flow channel containing the slurry; and adding the oxidizer to the slurry from a second hopper connected to the flow channel downstream from the first hopper.

In an example implementation (or aspect) combinable with any other example implementation (or aspect), the energetic material comprises from about 10 weight percent (wt. %) to about 25 wt. % of the thermoplastic polymer.

In an example implementation (or aspect) combinable with any other example implementation (or aspect), the energetic material comprises from about 20 volume percent (vol. %) to about 50 vol. % of the thermoplastic polymer.

In an example implementation (or aspect) combinable with any other example implementation (or aspect), the oxidizer comprises one or more of potassium nitrate, potassium perchlorate, ammonium nitrate, ammonium perchlorate, or sodium perchlorate.

In an example implementation (or aspect) combinable with any other example implementation (or aspect), the thermoplastic polymer comprises a thermoplastic polyurethane.

In an example implementation (or aspect) combinable with any other example implementation (or aspect), the thermoplastic polymer comprises a mixture of multiple thermoplastic polymers.

In an example implementation (or aspect), a method comprises: adding an oxidizer to a softened thermoplastic polymer composition to produce a mixture; and cooling the mixture of oxidizer and softened thermoplastic polymer composition to produce an energetic material comprising the oxidizer in a matrix of the thermoplastic polymer.

In an example implementation (or aspect) combinable with any other example implementation (or aspect), the method comprises softening the thermoplastic polymer.

In an example implementation (or aspect) combinable with any other example implementation (or aspect), softening the thermoplastic polymer comprises heating the thermoplastic polymer to a temperature above its melt temperature or glass transition temperature.

In an example implementation (or aspect) combinable with any other example implementation (or aspect), the method comprises, prior to adding the oxidizer to the softened thermoplastic polymer composition, dispersing a solid fuel additive in the softened thermoplastic polymer to produce the thermoplastic polymer composition, the thermoplastic polymer composition comprising a mixture of softened thermoplastic polymer and solid fuel additive.

In an example implementation (or aspect) combinable with any other example implementation (or aspect), the method comprises: dispersing the solid fuel additive in the softened thermoplastic polymer at a first manufacturing location; and adding the oxidizer to the softened thermoplastic polymer composition at a second manufacturing location remote from the first manufacturing location.

In an example implementation (or aspect) combinable with any other example implementation (or aspect), the method is performed as a continuous process.

In an example implementation (or aspect) combinable with any other example implementation (or aspect), the method comprises forming the energetic material into pellets.

In an example implementation (or aspect) combinable with any other example implementation (or aspect), the method comprises forming the energetic material into pellets sized to be used as feedstock for additive manufacturing.

In an example implementation (or aspect) combinable with any other example implementation (or aspect), the method comprises forming the energetic material into pellets having at least one dimension in the range of 2-4 mm.

In an example implementation (or aspect) combinable with any other example implementation (or aspect), forming the energetic material into pellets comprises: extruding the energetic material to produce an extrudate; and cutting the extrudate into pellets.

In an example implementation (or aspect) combinable with any other example implementation (or aspect), the method comprises storing the pellets.

In an example implementation (or aspect) combinable with any other example implementation (or aspect), the method comprises storing the pellets for at least 6 months.

In an example implementation (or aspect) combinable with any other example implementation (or aspect), the method comprises using the pellets as feedstock in an additive manufacturing process.

In an example implementation (or aspect) combinable with any other example implementation (or aspect), the additive manufacturing process comprises extruding the energetic material of the pellets from a nozzle of an additive manufacturing system.

In an example implementation (or aspect) combinable with any other example implementation (or aspect), the method comprises using the pellets as feedstock for additive manufacturing of a solid propellant grain for a solid rocket motor.

In an example implementation (or aspect) combinable with any other example implementation (or aspect), the method comprises using the pellets as feedstock for additive manufacturing of an explosive device.

In an example implementation (or aspect), a method comprises: at a first location, forming pellets of energetic material comprising an oxidizer in a matrix of a thermoplastic polymer; transporting the pellets to a second location; and at the second location, using the pellets as feedstock for manufacturing of an energetic device.

In an example implementation (or aspect) combinable with any other example implementation (or aspect), the method comprises using the pellets as feedstock for additive manufacturing of the explosive device.

In an example implementation (or aspect) combinable with any other example implementation (or aspect), forming the pellets comprising forming pellets of energetic material comprising a solid fuel additive and the oxidizer in the matrix of the thermoplastic polymer.

In an example implementation (or aspect), a method comprises: forming pellets of energetic material comprising an oxidizer in a matrix of a thermoplastic polymer; and storing the pellets.

In an example implementation (or aspect) combinable with any other example implementation (or aspect), forming the pellets comprising forming pellets of energetic material comprising a solid fuel additive and the oxidizer in the matrix of the thermoplastic polymer.

In an example implementation (or aspect), an energetic material comprises: a matrix of a thermoplastic polymer; and an oxidizer distributed in the thermoplastic polymer matrix.

In an example implementation (or aspect) combinable with any other example implementation (or aspect), the energetic material is in the form of filaments.

In an example implementation (or aspect) combinable with any other example implementation (or aspect), the energetic material is in the form of pellets.

In an example implementation (or aspect) combinable with any other example implementation (or aspect), the pellets of energetic material are sized to be used as feedstock for additive manufacturing.

In an example implementation (or aspect) combinable with any other example implementation (or aspect), the pellets of energetic material have at least one dimension in the range of 2-4 mm.

In an example implementation (or aspect) combinable with any other example implementation (or aspect), the energetic material comprises a solid propellant material.

In an example implementation (or aspect) combinable with any other example implementation (or aspect), the energetic material is in the form of a powder.

In an example implementation (or aspect) combinable with any other example implementation (or aspect), the energetic material comprises a solid fuel additive distributed in the thermoplastic polymer matrix.

In an example implementation (or aspect) combinable with any other example implementation (or aspect), the solid fuel additive comprises metal particles.

In an example implementation (or aspect) combinable with any other example implementation (or aspect), the metal particles comprise nanoscale or microscale metal particles.

In an example implementation (or aspect) combinable with any other example implementation (or aspect), the metal particles comprise nanoscale or microscale particles of aluminum.

In an example implementation (or aspect) combinable with any other example implementation (or aspect), the solid fuel additive and the oxidizer are present in the energetic material at a stoichiometric ratio with respect to combustion of the metal.

In an example implementation (or aspect) combinable with any other example implementation (or aspect), the energetic material comprises from about 10 weight percent (wt. %) to about 20 wt. % of the solid fuel additive.

In an example implementation (or aspect) combinable with any other example implementation (or aspect), the energetic material comprises from about 50 wt. % to about 75 wt. % of the oxidizer.

In an example implementation (or aspect) combinable with any other example implementation (or aspect), the energetic material comprises from about 10 wt. % to about 25 wt. % of the thermoplastic polymer.

In an example implementation (or aspect) combinable with any other example implementation (or aspect), the energetic material comprises from about 20 volume percent (vol. %) to about 50 vol. % of the thermoplastic polymer.

In an example implementation (or aspect) combinable with any other example implementation (or aspect), the oxidizer comprises one or more of potassium nitrate, potassium perchlorate, ammonium nitrate, ammonium perchlorate, or sodium perchlorate.

In an example implementation (or aspect) combinable with any other example implementation (or aspect), the thermoplastic polymer comprises a thermoplastic polyurethane.

In an example implementation (or aspect) combinable with any other example implementation (or aspect), the thermoplastic polymer comprises a mixture of multiple thermoplastic polymers.

In an example implementation (or aspect) combinable with any other example implementation (or aspect), the thermoplastic polymer has a melt temperature between about 120° C. and 190° C.

In an example implementation (or aspect) combinable with any other example implementation (or aspect), the energetic material has a melt temperature between about 120° C. and 190° C.

In an example implementation (or aspect) combinable with any other example implementation (or aspect), the energetic material has a glass transition temperature less than about −60° C.

In an example implementation (or aspect) combinable with any other example implementation (or aspect), the energetic material material is shelf stable at ambient temperature for at least 6 months.

In an example implementation (or aspect) combinable with any other example implementation (or aspect), the energetic material is formed by a method comprising: dissolving the thermoplastic polymer in a solvent to form a slurry; adding the oxidizer to the slurry; and after adding the oxidizer to the slurry, removing the solvent from the slurry to produce the energetic material.

In an example implementation (or aspect) combinable with any other example implementation (or aspect), the energetic material is formed by a method comprising: adding the oxidizer to the thermoplastic polymer; and cooling the mixture to produce an energetic material comprising the oxidizer in a matrix of the thermoplastic polymer.

In an example implementation (or aspect) combinable with any other example implementation (or aspect), the method comprises softening the thermoplastic polymer prior to adding the oxidizer.

In an example implementation (or aspect) combinable with any other example implementation (or aspect), a feedstock supply kit comprises: a container; and multiple pellets contained in the container, wherein the pellets are composed of the energetic material of any of the preceding example implementations or aspects.

In an example implementation (or aspect) combinable with any other example implementation (or aspect), the pellets are feedstock for an additive manufacturing tool.

In an example implementation (or aspect) combinable with any other example implementation (or aspect), the pellets are feedstock for injection molding.

In an example implementation (or aspect) combinable with any other example implementation (or aspect), the pellets are feedstock for spin casting.

In an example implementation (or aspect) combinable with any other example implementation (or aspect), the pellets are feedstock for manufacturing of a solid rocket motor.

In an example implementation (or aspect) combinable with any other example implementation (or aspect), the pellets are feedstock for manufacturing of an explosive device.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,”unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

1. An energetic material comprising:
a matrix of a thermoplastic polymer; and
an oxidizer distributed in the thermoplastic polymer matrix,
wherein the energetic material is in the form of pellets sized to be used as feedstock for additive manufacturing.

2. (canceled)

3. (canceled)

4. The energetic material of claim 1, wherein the pellets of energetic material have at least one dimension in the range of 2-4 mm.

5. The energetic material of claim 1, wherein the energetic material comprises a solid propellant material.

6. The energetic material of claim 1, wherein the energetic material is in the form of a powder.

7. The energetic material of claim 1, comprising a solid fuel additive distributed in the thermoplastic polymer matrix.

8. The energetic material of claim 7, wherein the solid fuel additive comprises metal particles.

9. The energetic material of claim 7, wherein the metal particles comprise nanoscale or microscale metal particles.

10. The energetic material of claim 7, wherein the metal particles comprise nanoscale or microscale particles of aluminum.

11. The energetic material of claim 7, wherein the solid fuel additive and the oxidizer are present in the energetic material at a stoichiometric ratio with respect to combustion of the metal.

12. The energetic material of claim 7, wherein the energetic material comprises from about 10 weight percent (wt. %) to about 20 wt. % of the solid fuel additive.

13. The energetic material of claim 1, wherein the energetic material comprises from about 50 wt. % to about 75 wt. % of the oxidizer.

14. The energetic material of claim 1, wherein the energetic material comprises from about 10 wt. % to about 25 wt. % of the thermoplastic polymer.

15. The energetic material of claim 1, wherein the energetic material comprises from about 20 volume percent (vol. %) to about 50 vol. % of the thermoplastic polymer.

16. The energetic material of claim 1, wherein the oxidizer comprises one or more of potassium nitrate, potassium perchlorate, ammonium nitrate, ammonium perchlorate, or sodium perchlorate.

17. The energetic material of claim 1, wherein the thermoplastic polymer comprises a thermoplastic polyurethane.

18. The energetic material of claim 1, wherein the thermoplastic polymer comprises a mixture of multiple thermoplastic polymers.

19. The energetic material of claim 1, wherein the thermoplastic polymer has a melt temperature between about 120° C. and 190° C.

20. The energetic material of claim 1, wherein the energetic material has a melt temperature between about 120° C. and 190° C.

21. The energetic material of claim 1, wherein the energetic material is shelf stable at ambient temperature for at least 6 months.

22. The energetic material of claim 1, wherein the energetic material is formed by a method comprising:
dissolving the thermoplastic polymer in a solvent to form a slurry;
adding the oxidizer to the slurry; and
after adding the oxidizer to the slurry, removing the solvent from the slurry to produce the energetic material.

23. The energetic material of claim 1, wherein the energetic material is formed by a method comprising:
adding the oxidizer to the thermoplastic polymer; and
cooling the mixture to produce an energetic material comprising the oxidizer in a matrix of the thermoplastic polymer.

24. The energetic material of claim 23, wherein the method comprises softening the thermoplastic polymer prior to adding the oxidizer.

25. A feedstock supply kit comprising:
a container; and
multiple pellets contained in the container, wherein the pellets are composed of the energetic material of claim 1.

26. The feedstock supply kit of claim 25, wherein the pellets are feedstock for an additive manufacturing tool.

27. The feedstock supply kit of claim 25, wherein the pellets are feedstock for injection molding.

28. The feedstock supply kit of claim 25, wherein the pellets are feedstock for spin casting.

29. The feedstock supply kit of claim 25, wherein the pellets are feedstock for manufacturing of a solid rocket motor.

30. The feedstock supply kit of claim 25, wherein the pellets are feedstock for manufacturing of an explosive device.
